(19) United States
(12) Patent Application Publication
(10) Pub. No.: US 2008/0264224 A1
(43) Pub. Date: Oct. 30, 2008

(54) Circular saw mechanism

(75) Inventor: Wen Pin Chen, Taichung (TW)

Correspondence Address: BACON & THOMAS, PLLC, 625 SLATERS LANE, FOURTH FLOOR, ALEXANDRIA, VA, 22314-1176, US

(73) Assignee: Rexon Industrial Corp., Ltd., Taichung (TW)

(21) Appl. No.: 12/081,719

(22) Filed: Apr. 21, 2008

(30) Foreign Application Priority Data
Apr. 26, 2007 (TW) 096114710

(51) Int. Cl. B26D 1/12

(52) U.S. Cl. 83/471.3

(57) ABSTRACT

A circular saw mechanism includes a base having a work surface for supporting a workpiece and a saw arm. The saw arm is pivotally connected to the base and is movable vertically upwards and downwards and includes a connecting device and a motor fixedly mounted thereon. A saw blade is mounted to the saw arm and is rotatable by the motor for cutting a workpiece on the work surface. A handle defining a plane is pivotally connected to the connecting device and is movable relative to the saw arm between a vertical position, where the plane is maintained perpendicular to the work surface, and a horizontal position, where the plane is maintained parallel to the work surface. The handle has a first grip and a second grip fixedly connected together, and an operating lever mounted to the first grip and operable to control operation of the motor.

### BACKGROUND

1. Field of the Invention

The present invention relates to circular saw mechanisms and more particularly, to a circular saw mechanism, which has a rotatable handle.

2. Description of the Related Art

FIG. 1 illustrates a conventional circular saw mechanism 10. According to this design, the circular saw mechanism 10 is a miter saw, comprising a saw blade 12, a base 14, a motor 16, a saw arm 18, a start switch 20, an operating handle 22, and a carrying handle 24. The base 14 is adapted for supporting a workpiece (not shown). The saw arm 18 has its rear end 26 pivotally connected to the rear side 28 of the base 14 so that the saw arm 18 is movable upwards and downwards relative to the base 14. The saw arm 18 also has its front part provided with a guard 30. The saw blade 12 is inserted into the guard 30. The motor 16 is installed in the saw arm 18, and is adapted for rotating the saw blade 12. The carrying handle 24 is a substantially U-shaped member vertically affixed to the saw arm 18 for holding by the user to carry the circular saw mechanism 10. The operating handle 22 has a substantially D-shaped profile, and is pivotally connected to the carrying handle 24. The start switch 20 is mounted to the operating handle 22, and is operable to start the motor 16. During operation, the user holds the operating handle 22 with one hand to operate the start switch 20 for rotating the saw blade 12 and to lower the saw arm 18, thus forcing the rotating saw blade 12 against the workpiece.

According to the aforesaid design, the operating handle 22 of the circular saw mechanism 10 is pivotally connected to the carrying handle 24. Therefore, the user can adjust the operating handle 22 to a vertical position or a horizontal position as desired. However, because the operating handle position adjustment design of the circular saw mechanism 10 requires the operating handle 22 and the carrying handle 24 to be separately made and then coupled together, a large assembly and installation space is necessary and the cost of the circular saw mechanism is also increased.

### SUMMARY

The present disclosure has been accomplished in view of the circumstances discussed above. Accordingly, embodiments of a circular saw mechanism having a rotatable handle are provided, which eliminate the drawbacks of the aforesaid prior art design.

An exemplary circular saw mechanism comprises a base, which has a work surface for supporting a workpiece, and a saw arm. The saw arm is pivotally connected to the base so as to be movable vertically upwards and downwards relative to the base and is lockable to the base in a selected position and has fixedly mounted thereon a connecting device and a motor. A saw blade is pivotally mounted to the saw arm and is rotatable by the motor for cutting a workpiece carried on the work surface. A handle defining a plane and pivotally connected to the connecting device is movable relative to the saw arm between a vertical position, where the plane is maintained perpendicular to the work surface, and a horizontal position, where the plane is maintained parallel to the work surface.

Further, the handle comprises a first grip, a second grip formed integrally with a part of the first grip, and an operating lever mounted to the first grip and operable to control operation of the motor. The second grip is liftable by a user to carry the circular saw mechanism when the saw arm is locked to the base and the handle is set in the vertical position as discussed below.

In one embodiment of the present disclosure, the handle is pivotally connected to the two distal ends of the connecting device and is movable relative to the connecting device between a vertical position and a horizontal position and is selectively lockable to the connecting device in at least the vertical position and the horizontal position. In other words, the first grip can be moved between the position where the first grip is maintained parallel to the saw blade and the position where the first grip is maintained perpendicular to the saw blade, and then subsequently locked to the connecting device in the parallel position or the perpendicular position. Therefore, the user can adjust the position of the first grip to the desired angle subject to one's operation preference. Further, the handle has a U-shaped profile, and the first grip and the second grip are an integral part of the handle, and therefore the U-shaped handle provides the function of an operating handle as well as the function of a carrying handle. This design simplifies the structure of the circular saw mechanism and reduces the manufacturing cost of the circular saw mechanism.

### BRIEF DESCRIPTION OF THE DRAWINGS

FIG. 1 is a perspective view of a circular saw mechanism according to the prior art.

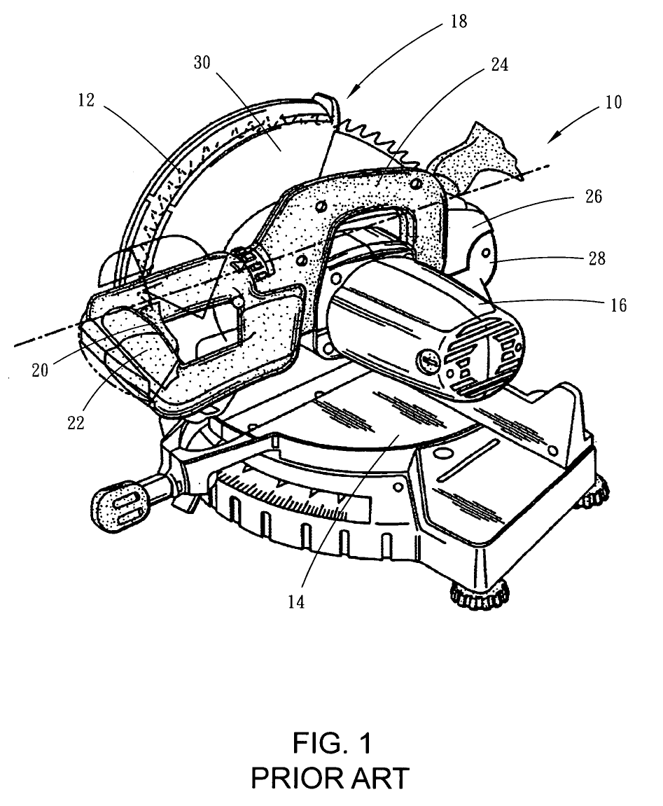

FIG. 2 is a perspective view of a circular saw mechanism in accordance with the present embodiment.

FIG. 3 is an exploded view of a part of the circular saw mechanism in accordance with the present embodiment, showing the structure of the handle and the internal structure of the connecting device.

FIG. 4 corresponds to FIG. 2, showing the handle in the horizontal position.

FIG. 5 is an exploded view of a part of the circular saw mechanism in accordance with the present embodiment, showing an alternate form of the handle and an alternate form of the internal structure of the connecting device.

FIG. 6 is a schematic side view of the circular saw mechanism in accordance with the present embodiment.

### DETAILED DESCRIPTION OF EMBODIMENTS

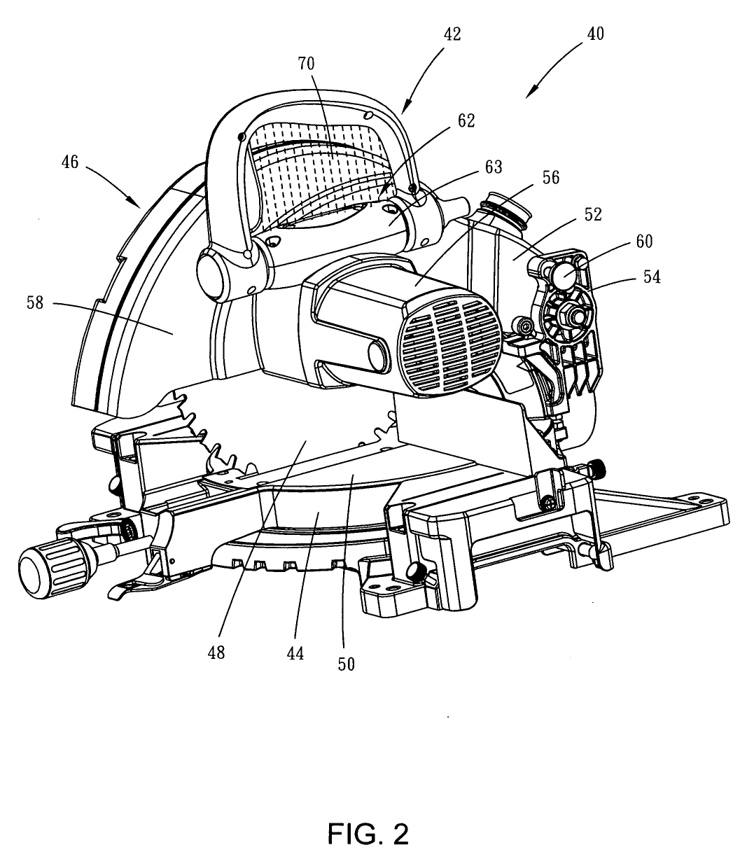

Referring to FIG. 2, a circular saw mechanism 40 in accordance with the present embodiment is shown having a handle 42 vertically oriented. The circular saw mechanism 40 according to this embodiment is a miter saw, comprising a base 44, a saw arm 46, a saw blade 48, and the aforesaid handle 42. The base 44 has a work surface 50 for supporting a workpiece for cutting. The saw arm 46 has a rear part 52 pivotally connected to a rear side 54 of the base 44 so that the saw arm 46 is movable upwards and downwards relative to the base 44. The saw arm 46 has its front part provided with a motor 56 and a guard 58. The saw blade 48 is mounted in the front part of the saw arm 46 and is inserted into the guard 58 for rotation by the motor 56 to cut the workpiece that is carried on the work surface 50 of the base 44.

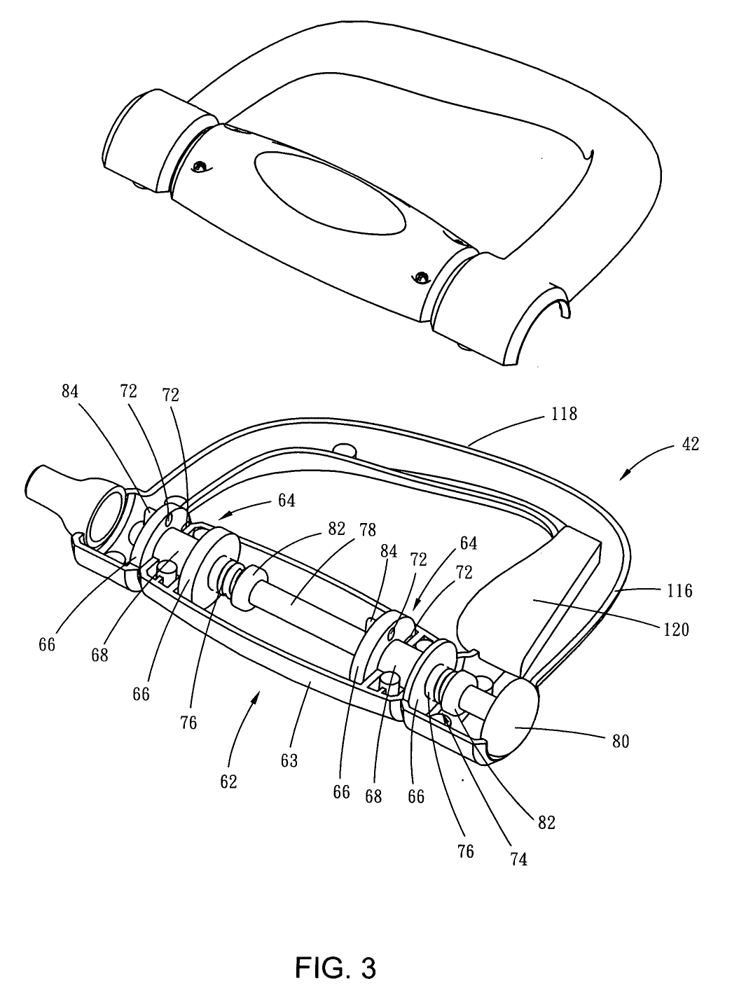

The circular saw mechanism 40 has a lock bolt 60 for holding the saw arm 46 in a predetermined position, normally the position where the saw arm 46 has been moved downwards relative to the base 44 to the lower limit position, to limit the motion of the saw arm 46, or even to prohibit the saw arm 46 from moving. The saw arm 46 is provided with a connecting device 62. The connecting device 62 comprises a barrel 63. The handle 42 has a U-shaped profile, defining therein a plane 70. The two ends of the handle 42 are respectively pivotally connected to the two ends of the barrel 63. The pivoting connection between the handle 42 and the barrel 63 can be achieved by any of a variety of techniques. The present preferred embodiment discloses only one example. According to the present preferred embodiment, as shown in FIG. 3, the handle 42 has two coupling devices 64 respectively mounted in the two distal ends. Each coupling device 64 comprises two wheels 66 with one disposed inside the barrel 63 and the other disposed outside the barrel 63, and a pivot axle 68 inserted through one end of the barrel 63 and having its two opposite ends respectively affixed to the center of each of the two wheels 66. Because the wheels 66 are not movable through the corresponding end of the barrel 63, the pivot axle 68 is pivotally coupled to the corresponding end of the barrel 63 and is not disconnectable from the barrel 63. By means of this arrangement, the handle 42 can be turned about the central axis of the pivot axles 68 of the coupling devices 64 relative to the barrel 63.

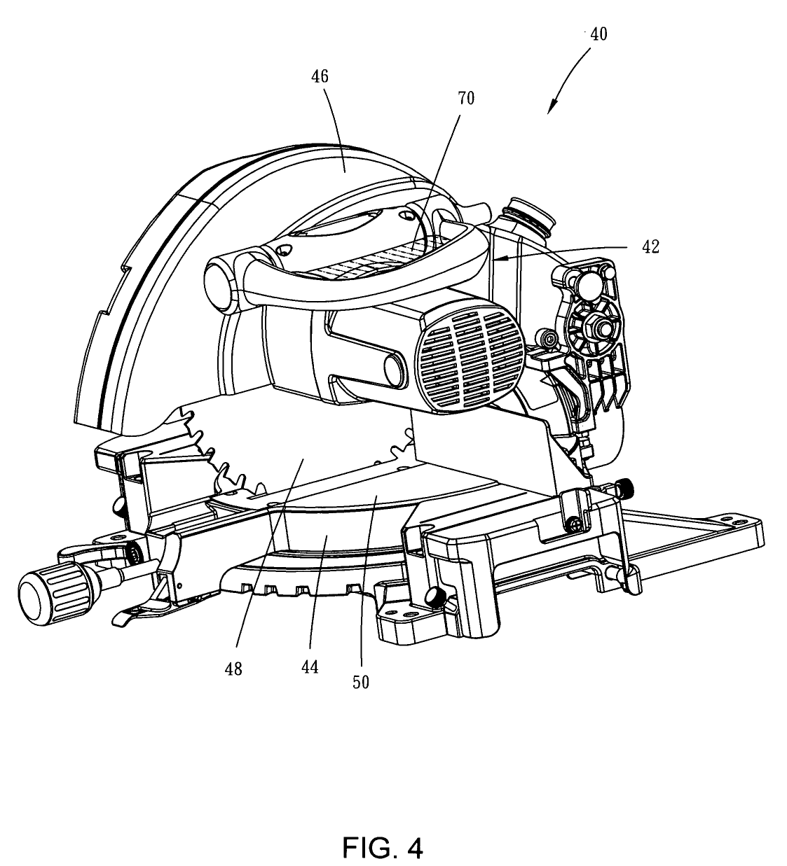

Referring again to FIG. 2 and also to FIG. 4, the movement angle of the handle 42 can be predetermined subject to the user's requirements during fabrication and installation of the circular saw mechanism 40. According to the present preferred embodiment, the handle 42 can be moved relative to the saw arm 46 between a vertical position in a parallel relationship relative to the saw blade 48 with the plane 70 maintained perpendicular to the work surface 50 of the base 44, as shown in FIG. 2, and a horizontal position in a perpendicular relationship relative to the saw blade 48 with the plane 70 maintained parallel to the work surface 50 and the base 44, as shown in FIG. 4. When moved to the vertical or horizontal position, the handle 42 can subsequently be locked in the respective position.

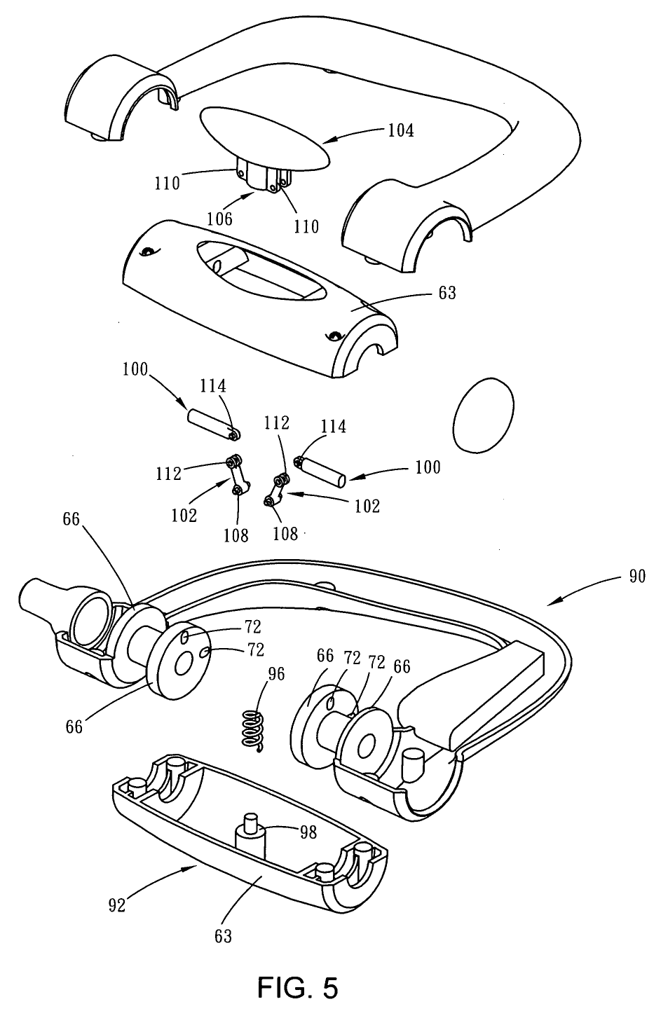

Further, the handle 42 can be locked to the saw arm 46 in the aforesaid vertical or horizontal position by means of any of a variety of techniques. Two exemplary locking structures are explained hereinafter with reference to FIGS. 3 and 5.

According to the locking structure shown in FIG. 3, the rear-sided (left-sided) wheels 66 of the coupling devices 64 each have two locating holes 72 that are oriented with respect to each other at a 90°-angle. The connecting device 62 comprises a control device 74. The control device 74 comprises two springs 76, a rod member 78, and a button 80 fixedly provided at one end of the rod member 78 and exposed to the outside of the handle 42.The rod member 78 is inserted through the two coupling devices 64, and has two collars 82 and two pins 84. The two pins 84 are fixedly provided at the periphery of the rod member 78. The springs 76 are mounted on the rod member 78 and are respectively retained between the front-sided (right-sided) wheels 66 of the coupling devices 64 and the collars 82. The springs thus impart a pressure to the collars 82 in a direction apart from the front-sided (right-sided) wheels 66 of the coupling devices 64 to force the pins 84 into one locating hole 72 on the rear-sided (left-sided) wheels 66 of the coupling devices 64. At this time, the handle 42 is locked to the saw arm 46 in either the vertical or horizontal position, depending upon which locating holes 72 the pins 84 are engaging. When the button 80 is pressed, the springs 76 are compressed, and the pins 84 are respectively disengaged from the respective locating holes 72, allowing rotation of the handle 42 relative to the connecting device 62 between the horizontal or vertical position. When the button 80 is released after the handle 42 has been turned to the desired position, the springs 76 immediately push back the collars 82 and the rod member 78, and therefore the pins 84 are forced into the corresponding locating holes 72 to lock the handle 42 in the adjusted position.

According to an embodiment as shown in FIG. 5, a handle 90 can be moved relative to a connecting device 92 between a horizontal position and a vertical position and then subsequently locked thereto. This embodiment is substantially similar to the embodiment shown in FIG. 3 with the exception that the locating holes 72 are respectively formed on the wheels 66 of the coupling devices 64 that are received inside the barrel 63. The control device of the connecting device 92 comprises a spring 96, a bolt 98, two pins 100, two links 102, and a button 104. The bolt 98 is fixedly provided inside the barrel 63. The spring 96 is disposed on the bolt 98, having one end inserted into the bottom wall 106 of the button 104 to impart an upward pressure to the button 104. The links 102 each have one end 108 pivotally connected to one of two opposite sides 110 of the bottom wall 106 of the button 104 and the other end 112 pivotally connected to one end 114 of each of the two pins 100. Normally, the two pins 100 are respectively inserted into one locating hole 72 on each of the two wheels 66 of the coupling devices 64 that are received inside the barrel 63 to lock the handle 90 in the selected position. The button 104 is exposed to the outside of the barrel 63. When the button 104 is pressed, the spring 96 is also compressed, and the two pins 100 are disengaged from the corresponding locating holes 72. At this time, the user can move the handle 90 between the horizontal position and the vertical position. When the handle 90 is moved to the horizontal or vertical position and the button 104 is released, the spring 96 returns to its former shape to push the button 104 upward to its former unactuated position, and the pins 100 are forced into engagement with the respective locating holes 72, thus locking the handle 90 in the selected position again.

The arrangement of the number and locations of the aforesaid locating holes 72 determines the number of positions in which the handle 42 or 90 is selectively lockable to the connecting device 62 or 92 (the saw arm). By means of increasing the number of locating holes 72, the number of positions in which the handle 42 or 90 can be selectively positioned is relatively increased, such that any desired position may be chosen.

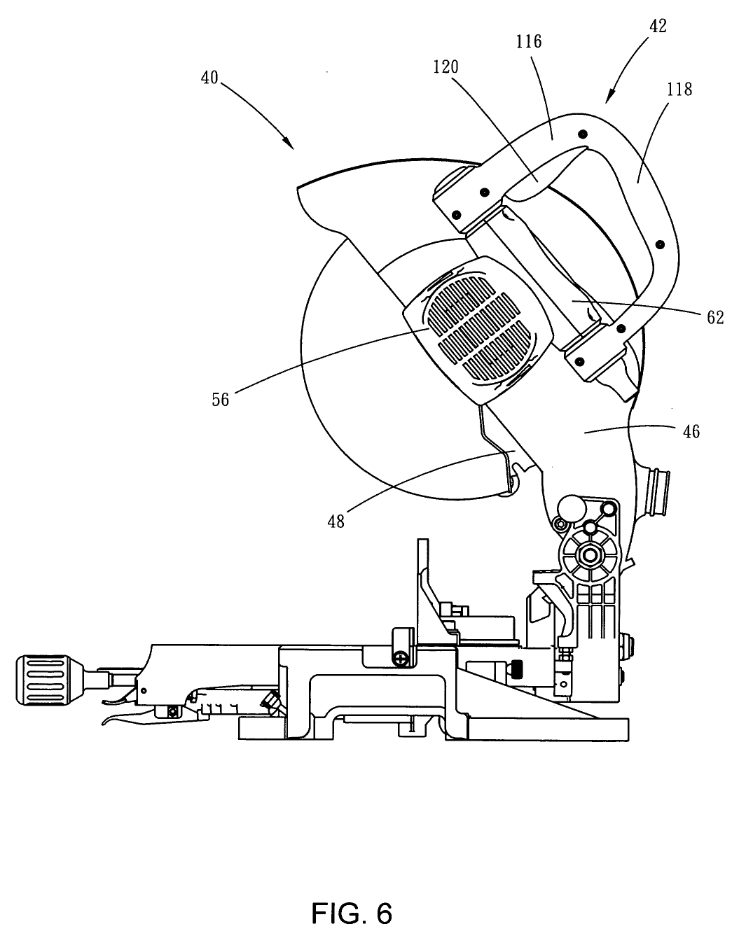

Turning to FIG. 6 and to FIG. 3 again, the handle 42 comprises a first grip 116, a second grip 118, and an operating lever 120. The first grip 116 extends in a direction substantially perpendicular to the connecting device 62, and has one end connected to the wheels 66 positioned outside the barrel 63 so that the first grip 116 is pivotally coupled to the connecting device 62. The operating lever 120 is coupled to an inner side of the first grip 116 and operable to switch on/off the motor 56. During operation, the user holds the first grip 116 and operates the operating lever 120 to control rotation of the saw blade 48 and to lower the saw blade 48, thus forcing the saw blade 48 to cut the workpiece. The second grip 118 is connected to the first grip 116. When the saw arm 46 is locked to the base 44 and the handle 42 is locked to the saw arm 46 in the vertical position, the user can hold the second grip 118 to conveniently carry the circular saw mechanism 40.

As stated above, by means of the arrangement of the coupling devices 64 and the control device 74, the handle 42 is connected to the two distal ends of the connecting device 62 and is movable relative to the connecting device 62 between a vertical position and a horizontal position and is lockable to the connecting device 62 in the selected position. In other words, the first grip 116 can be moved between the position where the first grip 116 is maintained parallel to the saw blade 48 and the position where the first grip 116 is maintained perpendicular to the saw blade 48 and then subsequently locked to the connecting device 62 in the selected position. Therefore, the user can adjust the position of the first grip 116 to the desired angle subject to one's operation preference. Further, the first grip 116 and the second grip 118 are an integral part of the handle 42, such that the U-shaped handle 42 provides the function of an operating handle as well as the function of a carrying handle. This design simplifies the structure of the circular saw mechanism and reduces its manufacturing cost.

Although particular embodiments of the invention have been described in detail for purposes of illustration, various modifications and enhancements may be made without departing from the spirit and scope of the invention. Accordingly, the invention is not to be limited except as by the appended claims

What is claimed is:

1. A circular saw mechanism comprising:
a base having a work surface arranged for supporting a workpiece;
a saw arm pivotally connected to said base and movable vertically upwards and downwards relative to said base and lockable to said base in a selected position, said saw arm having fixedly mounted thereon a connecting device and a motor;
a saw blade pivotally mounted on said saw arm and rotatable by said motor; and
a handle defining a plane and pivotally connected to said connecting device and movable relative to said saw arm between a vertical position where said plane is maintained perpendicular to said work surface and a horizontal position where said plane is maintained parallel to said work surface, said handle comprising a first grip, a second grip formed integral with a part of said first grip, and an operating lever mounted to said first grip and operable to control operation of said motor, said second grip configured for lifting by a person to carry said circular saw mechanism when said saw arm is locked to said base and said handle is set in said vertical position.

2. The circular saw mechanism according to claim 1, wherein said handle has a U-shaped profile, and two distal ends respectively pivotally connected to said connecting device.

3. The circular saw mechanism according to claim 2, wherein said first grip has one end pivotally coupled to said connecting device.

4. The circular saw mechanism according to claim 3, wherein said first grip extends substantially perpendicular to said connecting device.

5. The circular saw mechanism according to claim 2, further comprising a locking mechanism adapted for locking said handle to said connecting device, said locking mechanism comprising a wheel mounted on one of said connecting device and one end of said handle, a plurality of locating holes formed in said wheel, and a pin mounted on the other of said connecting device and the respective end of said handle and selectively disconnectably inserted into one of said locating holes to lock said handle to said connecting device.

6. The circular saw mechanism as claimed in claim 1, wherein when said handle is in said vertical position, said plane is maintained parallel to one side of said saw blade; and when said handle is in said horizontal position, said plane is maintained perpendicular to the corresponding side of said saw blade.

7. A circular saw mechanism comprising:
a base having a work surface arranged for supporting a workpiece;
a saw arm pivotally connected to said base and movable vertically upwards and downwards relative to said base and lockable to said base in a selected position, said saw arm having fixedly mounted thereon a connecting device and a motor;
a saw blade pivotally mounted to said saw arm and rotatable by said motor; and
a handle defining a plane and pivotally connected to said connecting device and movable relative to said saw arm between a vertical position where said plane is maintained perpendicular to said work surface and parallel to one side of said saw blade and a horizontal position where said plane is maintained parallel to said work surface and perpendicular to the corresponding side of said saw blade, said handle comprising a first grip, a second grip formed integral with a part of said first grip, and an operating lever mounted to said first grip and operable to control operation of said motor, said second grip configured for lifting by a person to carry said circular saw mechanism when said saw arm is locked to said base and said handle is set in said vertical position.

8. The circular saw mechanism according to claim 7, wherein said handle has a U-shaped profile; said first grip has one end thereof pivotally connected to said connecting device and is maintained perpendicular to said connecting device.

9. The circular saw mechanism according to claim 8, further comprising a locking mechanism adapted for locking said handle to said connecting device, said locking mechanism comprising a wheel mounted on one of said connecting device and one end of said handle, a plurality of locating holes formed in said wheel, and a pin mounted on the other of said connecting device and the respective end of said handle and selectively disconnectably inserted into one of said locating holes to lock said handle to said connecting device.

10. A circular saw mechanism comprising:
a base having a work surface arranged for supporting a workpiece;
a saw arm pivotally connected to said base and movable vertically upwards and downwards relative to said base and lockable to said base in a selected position, said saw arm having fixedly mounted thereon a connecting device and a motor;
a saw blade pivotally mounted to said saw arm and rotatable by said motor; and
a handle defining a plane and pivotally connected to said connecting device and movable relative to said saw arm between a vertical position where said plane is maintained perpendicular to said work surface and a horizontal position where said plane is maintained parallel to said work surface, said handle comprising a first grip, a second grip formed integral with a part of said first grip, and an operating lever mounted to said first grip and operable to control operation of said motor, said second grip configured for lifting by a person to carry said circular saw mechanism when said saw arm is locked to said base and said handle is set in said vertical position; and
a wheel mounted on one of said connecting device and one end of said handle, a plurality of locating holes formed in said wheel, and a pin mounted on the other of said connecting device and the respective end of said handle and selectively disconnectably inserted into one of said locating holes to lock said handle to said connecting device.
